(19) United States
(12) Patent Application Publication
(10) Pub. No.: US 2003/0054276 A1
(43) Pub. Date: Mar. 20, 2003

(54) Black toner for two-component development

(76) Inventors: Shinji Moriyama, Wakayama-shi (JP); Yasuyuki Tamane, Osaka (JP); Hidenori Tachi, Wakayama-shi (JP); Yoshihiro Fukushima, Wakayama-shi (JP); Koji Akiyama, Wakayama-shi (JP)

Correspondence Address: BIRCH STEWART KOLASCH & BIRCH, PO BOX 747, FALLS CHURCH, VA, 22040-0747, US

(21) Appl. No.: 10/131,199

(22) Filed: Apr. 25, 2002

(30) Foreign Application Priority Data
Apr. 27, 2001 (JP) 2001-133643

(51) Int. Cl. G03G 9/083

(52) U.S. Cl. 430/106.2; 430/108.6; 430/111.41; 430/111.4; 430/109.4

(57) ABSTRACT

A black toner for two-component development, comprising a resin binder; and a black colorant comprising a composite oxide of two or more metals, the composite oxide having a BET specific surface area of 7 m²/g or more; and a two-component developer comprising the black toner for two-component development and a resin-coated carrier. The black toner for two-component development can be suitably used for the development of a latent image formed in electrophotography, electrostatic recording method, electrostatic printing method or the like.

### BACKGROUND OF THE INVENTION

1. Field of the Invention

The present invention relates to a black toner for two-component development used for the development of a latent image formed in electrophotography, electrostatic recording method, electrostatic printing method or the like, and a two-component developer comprising the black toner.

2. Discussion of the Related Art

In the electrophotographic copy machines and printers, high image quality including photographic reproducibility has been required. Therefore, from the viewpoint of high image quality, there has been proposed that a metal oxide is used as a black colorant as a substitute for carbon black having a low resistance (Japanese Patent Laid-Open Nos. 2000-10344, Hei 9-25126, Hei 4-144924, Hei 3-2276, and the like).

However, metal oxides have a low blackened degree. Therefore, when a metal oxide is contained in a large amount in order to obtain the same blackened degree as that of carbon black, toner scattering is generated due to the increase in the true specific gravity. Further, the halftone reproducibility is insufficient and the flare (line generated on a tip end part of a solid image) is generated.

An object of the present invention is to provide a black toner for two-component development which has an excellent blackened degree, little toner scattering, and excellent halftone reproducibility, and can prevent causation of flare, and a two-component developer comprising the black toner.

These and other objects of the present invention will be apparent from the following description.

### SUMMARY OF THE INVENTION

The present invention relates to a black toner for two-component development comprising a resin binder and a black colorant comprising a composite oxide of two or more metals, the composite oxide having a BET specific surface area of 7 m²/g or more; and a two-component developer comprising the black toner for two-component development and a resin-coated carrier.

### BRIEF DESCRIPTION OF THE DRAWINGS

FIG. 1 is a photomicrograph of the halftone image obtained by using the toner of Example 1 of the present specification.

FIG. 2 is a photomicrograph of the halftone image obtained by using the toner of Comparative Example 2 of the present specification.

FIG. 3 is a photomicrograph of the flare obtained by using the toner of Example 11 of the present specification.

FIG. 4 is a photomicrograph of the flare obtained by using the toner of Comparative Example 4 of the present specification.

### DETAILED DESCRIPTION OF THE INVENTION

One of the greatest features of the toner of the present invention resides in that the toner comprises a black colorant comprising a composite oxide having a specified BET specific surface area. The present inventors have found that an excellent blackened degree can be obtained and that reduction of toner scattering, improvement in halftone reproducibility, and prevention of flare can be attained by using a composite oxide having a specified BET specific surface area, since the blackened degree and the surface resistivity of a black colorant are affected by the specific surface area. Specifically, when the true specific gravity of a toner is high, toner scattering is generated by the effect of the centrifugal force applied on the magnet roller during the development. However, in the present invention, since the toner comprises a composite oxide having a large BET specific surface area, a sufficient blackened degree can be secured with a small added amount, so that the true specific gravity of the toner can be reduced. Further, an appropriate surface resistivity is attained so that the toner has appropriate triboelectric charges and a narrow distribution of triboelectric charges, which in turn contributes to suppression of toner scattering, and further to improvement in halftone reproducibility and prevention of flare.

The preferred specific surface area of the composite oxide in the present invention differs depending upon the kinds of the metals constituting the composite oxide. The composite oxide has a specific surface area as determined by the BET method, i.e., a BET specific surface area, of 7 m²/g or more, preferably 10 m²/g or more, more preferably 15 m²/g or more, still more preferably 30 m²/g or more, especially preferably 40 m²/g or more. The BET specific surface area is preferably 300 m²/g or less, more preferably 200 m²/g or less, especially preferably 100 m²/g or less, from the viewpoints of the handleability and the resistivity adjustment.

The composite oxide has an average particle size of preferably from 5 nm to 1 μm, more preferably from 5 to 450 nm, especially preferably from 5 to 200 nm, from the viewpoints of the BET specific surface area and the covering strength.

The composite oxide is preferably low-magnetic, more preferably nonmagnetic. Here, the term “low-magnetic” as used herein refers to those having a magnetic property showing a magnetization of 0.1 to 50 Am²/kg (emu/g) when a magnetic field of 796 kA/m (10 kOe) is applied, and the term “nonmagnetic” refers to those having a magnetic property showing a magnetization of 0.1 to 10 Am²/kg when a magnetic field of 796 kA/m is applied.

In the present invention, the composite oxide is constituted by at least 2 metals, from the viewpoints of the blackened degree of the toner and the control of the magnetic properties. Especially, it is preferable that at least one, preferably at least two, of the composite oxide are titanium (Ti), vanadium (V), chromium (Cr), manganese (Mn), iron (Fe), cobalt (Co), nickel (Ni), copper (Cu), aluminum (Al) or magnesium (Mg). Among them, Ti, Mn, Fe, Cu, Mg and Al are preferable, and Ti, Mn, Fe, Cu, Mg and Al are especially preferable. The compositional ratio of the metals in the composite oxide is not particularly limited.

The content of the composite oxide is preferably 30 parts by weight or less, more preferably from 3 to 20 parts by weight, especially preferably from 6 to 17 parts by weight, based on 100 parts by weight of the resin binder, from the viewpoints of the blackened degree and the specific gravity of the toner.

The process for preparing a composite oxide includes a process comprising depositing other oxide on a surface of the main oxide used as a core particle (Japanese Patent Laid-Open No. 2000-10344), a process of making a composite oxide comprising sintering several oxides (Japanese Patent Laid-Open No. Hei 9-25126), and the like, without being particularly limited thereto.

The preferable commercially available composite oxide in the present invention includes “Dye Pyroxide Black No. 1,” “Dye Pyroxide Black No. 2” (hereinabove commercially available from DAINICHISEIKA COLOR & CHEMICALS MFG. CO., LTD.), “HSB-603Rx” (commercially available from Toda Kogyo Corp.), “ETB-200” (commercially available from Titan Kogyo K.K.), “K-002” (commercially available from Toda Kogyo Corp.), MC Series (commercially available from MITSUI MINING & SMELTING CO., LTD.), and the like.

The toner of the present invention may contain in an appropriate amount a known colorant other than the above-mentioned composite oxide as a colorant. Especially when the colorant is used together with carbon black, the content of the carbon black can be remarkably reduced.

The resin binder in the present invention includes polyesters, styrene-acrylic resins, epoxy resins, polycarbonates, polyurethanes, hybrid resins in which two or more resin components are partially chemically bonded, without being particularly limited thereto. Among them, from the viewpoints of the dispersibility and the transferability of the colorant, the polyesters, and the hybrid resins comprising a polyester component and a styrene-acrylic resin component are preferable, and the polyesters are more preferable. The content of the polyester is preferably from 50 to 100% by weight, more preferably from 80 to 100% by weight, especially preferably 100% by weight, of the resin binder.

The hybrid resin may be obtained by using two or more resins as raw materials, or it may be obtained by using one resin and raw material monomers of the other resin. Further, the hybrid resin may be obtained from a mixture of raw material monomers of two or more resins. In order to efficiently obtain a hybrid resin, those obtained from a mixture of raw material monomers of two or more resins are preferable.

The raw material monomers for the polyester include known dihydric or higher polyhydric alcoholic components and known carboxylic acid components such as dicarboxylic or higher polycarboxylic acids, anhydrides thereof and esters thereof.

It is preferable that the alcoholic component contains a compound represented by the formula (I):

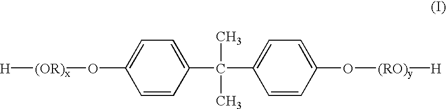

wherein R is an alkylene group having 2 or 3 carbon atoms; x and y are a positive number; and the sum of x and y is from 1 to 16, preferably from 1.5 to 5.0.

The compound represented by the formula (I) includes alkylene(2 or 3 carbon atoms) oxide(average number of moles added: 1 to 16 moles) adducts of bisphenol A such as polyoxypropylene(2.2)-2,2-bis(4-hydroxyphenyl)propane and polyoxyethylene(2.2)-2,2-bis(4-hydroxyphenyl)propane, and the like. In addition, other alcoholic components include ethylene glycol, 1,2-propylene glycol, 1,4-butanediol, neopentyl glycol, polyethylene glycol, polypropylene glycol, bisphenol A, hydrogenated bisphenol A, sorbitol, pentaerythritol, glycerol, trimethylolpropane, or alkylene(2 to 4 carbon atoms) oxide(average number of moles added: 1 to 16 moles) adducts thereof, and the like, and it is preferable that these compounds can be contained in the alcoholic component alone or in admixture of two or more kinds.

It is desired that the content of the compound represented by the formula (I) is 5% by mole or more, preferably 50% by mol or more, more preferably 100% by mol, of the alcoholic component.

Also, the dicarboxylic acid component includes, for instance, dicarboxylic acids such as maleic acid, fumaric acid, phthalic acid, isophthalic acid, terephthalic acid, adipic acid, and succinic acid; a substituted succinic acid of which substituent is an alkyl group having 1 to 20 carbon atoms or an alkenyl group having 2 to 20 carbon atoms, such as tetrapropenylsuccinic acid, n-dodecenylsuccinic acid, isododecenylsuccinic acid, n-dodecylsuccinic acid, isooctenylsuccinic acid and isooctylsuccinic acid; acid anhydrides thereof or lower alkyl(1 to 3 carbon atoms) esters thereof; and the like.

The tricarboxylic or higher polycarboxylic acid component includes, for instance, 1,2,4-benzenetricarboxylic acid (trimellitic acid), 2,5,7-naphthalenetricarboxylic acid, pyromellitic acid, acid anhydrides, lower alkyl(1 to 3 carbon atoms) esters thereof, and the like. Among them, trimellitic acid is preferable. The content of the tricarboxylic or higher polycarboxylic acid component is preferably from 5 to 50% by mol, more preferably from 10 to 30% by mol, of the carboxylic acid component.

The polyester can be prepared by, for instance, polycondensation of an alcoholic component with a carboxylic acid component or the like under reduced pressure at a temperature of 180° to 250° C. in an inert gas atmosphere using an esterification catalyst as desired.

It is preferable that the polyester has an acid value of from 0.5 to 60 mg KOH/g, from the viewpoint of the dispersibility of the colorant and the transferability, and that the polyester has a hydroxyl value of from 1 to 60 mg KOH/g.

In addition, the polyester has a softening point of 80° to 165° C., and a glass transition point of 50° to 85° C.

It is preferable that the toner of the present invention has a dielectric loss tangent (tan δ) of preferably from 0.001 to 0.006, more preferably from 0.002 to 0.004, from the viewpoint of the dispersibility of the composite oxide in the toner, i.e., the chargeability of the toner. The dielectric loss tangent (tan δ) of the toner can be adjusted by changing the kinds and the amounts of the raw materials, the time for pre-mixing the raw materials, and various conditions in the kneading step, and the like.

The toner of the present invention may contain a magnetic powder in order to suppress toner scattering. The magnetic powder includes powders of alloys such as magnetite, hematite and ferrite; powders of a ferromagnetic metal such as iron, cobalt and nickel, and the like. It is preferable that the amount of the magnetic powder added is from 0.5 to 10 parts by weight based on 100 parts by weight of the resin binder.

Further, the toner of the present invention may appropriately contain an additive such as a charge control agent, a releasing agent, a fluidity improver, an electric conductivity modifier, an extender, a reinforcing filler such as a fibrous substance, an antioxidant, an anti-aging agent, and a cleanability improver.

The charge control agent includes positively chargeable charge control agents such as Nigrosine dyes, triphenylmethane-based dyes containing a tertiary amine as a side chain, quaternary ammonium salt compounds, polyamine resins and imidazole derivatives, and negatively chargeable charge control agents such as metal-containing azo dyes, copper phthalocyanine dyes, metal complexes of alkyl derivatives of salicylic acid and boron complexes of benzilic acid. It is preferable that the toner of the present invention is a positively chargeable toner containing a positively chargeable charge control agent, from the viewpoint of giving the dispersibility of the composite oxide, thereby making the triboelectric charges even.

The toner of the present invention can be prepared by any of conventionally known methods such as kneading and pulverization method, polymerization method, and phase inversion method. In a case of a pulverized toner prepared by kneading and pulverization method, for instance, the toner can be prepared by homogeneously pre-mixing a resin binder, a colorant, and the like in a mixer such as a Henschel mixer or a ball-mill, thereafter melt-kneading with a closed kneader or a single-screw or twin-screw extruder, cooling, pulverizing and classifying the product. The volume-average particle size of the toner is preferably from 3 to 15 μm. Further, a fluidity improver such as hydrophobic silica or the like may be added to the surface of the toner as an external additive.

The toner of the present invention is mixed with a carrier and used as a two-component developer. It is preferable that the carrier is a resin-coated carrier in which the surface of the core material is coated with a resin. The core material may have any of a spherical shape, a regular shape and an irregular shape, and the material includes an iron powder, magnetite, ferrite, and the like, among which magnetite and ferrite are preferable, and ferrite is more preferable.

The resin for coating on the surface of the core material includes a known coating agent such as a fluororesin, a silicone resin, an acrylic resin, a polyester resin, a polyolefin resin, an urethane resin or the like. Among them, a fluororesin and a silicone resin which have a low surface energy are preferable. It is preferable that the carrier is a fluororesin which has a high electronegativity since the carrier is negatively charged when used together with a positively chargeable toner.

The fluororesin includes perfluoropolymers such as polyvinyl fluoride, polyvinylidene fluoride, polytrifluoroethylene, polytrifluorochloroethylene, polytetrafluoroethylene, polyperfluoropropylene; vinylidene fluoride-based fluororeins such as copolymers of vinylidene fluoride and at least one resin such as acrylic acid, trifluorochloroethylene, vinyl fluoride, tetrafluoroethylene or hexafluoropropylene, and the like.

In the present invention, in the case where the coating agent comprises a fluororesin, it is preferable that an acrylic resin is additionally contained in the coating agent from the viewpoint of enhancing the adhesive strength to the core material, thereby improving the durability of the carrier. Here, the acrylic resin is preferably a (co)polymer comprising as a major component one or more monomers selected from an alkyl(1 to 18 carbon atoms) ester of (meth)acrylic acid and a styrene derivative, more preferably a (co)polymer comprising as a major component one or more monomers selected from styrene, methyl methacrylate and butyl acrylate, especially preferably a (co)polymer comprising methyl methacrylate as a major component.

Incidentally, additives such as a charge control agent, a colorant, and the like may be contained in appropriate amounts in the resin.

It is preferable that the fluororesin is contained in an amount of 50% by weight or more in the resin for coating the core material. In the case where the acrylic resin is further contained, the content of the acrylic resin is preferably from 25 to 100 parts by weight, more preferably from 40 to 90 parts by weight, especially preferably from 50 to 80 parts by weight, based on 100 parts by weight of the fluororesin.

The core material can be coated with the resin by, for example, dissolving the resin in an organic solvent or the like, applying the solution onto the surface of the carrier by dipping, spraying or the like, and thereafter carrying out drying, thermally curing or the like to form a coating film.

The carrier has a volume-average particle size of preferably from 50 to 200 μm, more preferably from 60 to 150 μm, especially preferably from 70 to 130 μm.

When the toner is mixed with the carrier to give a two-component developer, the weight ratio of the toner to the carrier (toner/carrier) is preferably from 0.5/100 to 8/100, more preferably from 1/100 to 6/100.

The black toner for two-component development of the present invention has a high blackened degree, little toner scattering, and excellent fine halftone reproducibility, and can prevent causation of flare. Therefore, the black toner for two-component development of the present invention can be suitably used not only for charged area development but also for non-charged area development (reversal development).

Further, since the black toner for two-component development of the present invention has a resistance similar to that of colorants such as yellow, cyan and magenta, the black toner is suitably used in the formation of full-color fixed images.

Furthermore, the present invention provides a process for development of a two-component developer, comprising applying the two-component developer of the present invention to a development device for two-component development. In this process, it is preferable that the development device is a device for reversal development, or a device for full-color development.

### EXAMPLES

[BET Specific Surface Area of Composite Oxide]

The BET specific surface area of a composite oxide is determined by the nitrogen adsorption method.

[Magnetic Properties of Composite Oxide]

(1) A composite oxide is filled in a plastic case with a lid with tapping, the case having an external diameter of 7 mm and a height of 5 mm. The mass of the composite oxide is determined from the difference of the weight of the plastic case and the weight of the plastic case filled with the composite oxide.

(2) The plastic case filled with the composite oxide is set in a sample holder of a magnetization measuring device “BHV-50H” (V.S. MAGNETOMETER) commercially available from Riken Denshi Co., Ltd. The magnetic properties are determined by applying a magnetic field, with vibrating the plastic case using the vibration function. The value obtained is calculated as magnetic properties per unit mass, taking into consideration the mass of the filled composite oxide.

[Softening Point of Resin]

The softening point of a resin is determined by a method according to ASTM D36-86.

[Glass Transition Point of Resin]

The glass transition point of a resin is determined using a differential scanning calorimeter “DSC Model 210” (commercially available from Seiko Instruments, Inc.) with raising the temperature at a rate of 10° C./min.

[Acid Value and Hydroxyl Value of Resin]

The acid value and the hydroxyl value are determined by a method according to JIS K 0070.

[Dielectric Loss Tangent of Toner]

Five grams of a toner is supplied in a press die for tabletting having an inner diameter of 59 mm so that the toner surface is even. The die is set in an electric sample-molding machine (C/N: 9302/30, commercially available from Maekawa Shiken-ki), and a pressure of 10 tons by the scale on a Bourdon's tube pressure gauge provided in the machine is applied for 10 seconds, to give a toner pellet having a diameter of 59 mm and a thickness of about 1.7 mm.

The dielectric loss tangent of the resulting toner pellet is determined at 1 kHz under the environment of a temperature of 25° C. and a relative humidity of 50%, using a precision LCR meter; HP 4284 and an electrode for dielectric determination; HP 16451 B (electrode used: Electrode A) (both commercially available from YOKOGAWA Hewlett-Packard).

### Preparation Example 1 of Resin

Seven-hundred and thirty five grams of polyoxypropylene(2.2)-2,2-bis(4-hydroxyphenyl)propane, 293 g of polyoxyethylene(2.2)-2,2-bis(4-hydroxyphenyl)propane, 280 g of isophthalic acid, 60 g of isooctenylsuccinic acid, 72 g of trimellitic acid and 2 g of dibutyltin oxide were reacted at 230° C. in vacuo under a nitrogen gas stream with stirring. The reaction was terminated when the softening point reached 136° C. The resulting resin is referred to as a resin A. The resin A was a pale yellow solid having a glass transition point of 63° C., an acid value of 3.1 mg KOH/g and a hydroxyl value of 35.2 mg KOH/g.

### Preparation Example 2 of Resin

Nine-hundred grams of polyoxypropylene(2.2)-2,2-bis(4-hydroxyphenyl)propane, 250 g of neopentyl glycol, 580 g of terephthalic acid, 130 g of trimellitic anhydride and 2 g of dibutyltin oxide were reacted at 230° C. in vacuo under a nitrogen gas stream with stirring. The polymerization degree was monitored by the acid value, and the reaction was terminated when the acid value reached 10.2 mg KOH/g. The resulting resin is referred to as a resin B. The resin B was a pale yellow solid having a glass transition point of 66° C., a softening point of 145° C., an acid value of 10.2 mg KOH/g and a hydroxyl value of 45.2 mg KOH/g.

### Preparation Example 3 of Resin

A mixture of 800 g of styrene, 300 g of n-butyl acrylate, and 26 g of dicumyl peroxide was added dropwise to 550 g of xylene under a nitrogen gas atmosphere at 135° C. over 1 hour, and the mixture was further matured for 2 hours. Thereafter, xylene was removed under reduced pressure, to give a resin C. The resin C was a white solid having a glass transition point of 65° C. and a softening point of 138° C.

### Preparation Example 1 of Carrier

To 6 parts by weight of a fluororesin “HYLAR 301 F” (commercially available from Ausmond), 4 parts by weight of an acrylic resin “Dyanal BR-80” (commercially available from Mitsubishi Rayon Co., Ltd.), based on 1000 parts by weight of a commercially available magnetite core carrier, was added methyl ethyl ketone, to prepare a resin solution for coating the core material. This resin solution was spray-coated on the core material using a fluidized-coating device. Thereafter, a heat treatment was carried out at 100° C. for 60 minutes in the fluidized bed, to give a resin-coated magnetite carrier A having an average particle size of 110 μm.

### Examples 1 to 12 and Comparative Examples 1 to 4

Two parts by weight of a charge control agent “BONTRON N-01” (commercially available from Orient Chemical Co., Ltd.), 1.5 parts by weight of a releasing agent “Viscol 660P” (commercially available from SANYO CHEMICAL INDUSTRIES, LTD.) and the raw materials as shown in Table 1 were pre-mixed with a Henschel Mixer for a specified time period as shown in Table 1. Thereafter, the mixture was melt-kneaded with a twin-screw kneader, cooled, pulverized and classified, to give a powder having a volume-average particle size of 10 μm.

To 100 parts by weight of the resulting powder, 0.3 parts by weight of a hydrophobic silica “HVK 2150” (commercially available from Clariant) were mixed and adhered with a Henschel Mixer, to give a toner.

Thirty-nine parts by weight of the resulting toner and 1261 parts by weight of a resin-coated magnetite carrier A were mixed with a Nauta Mixer, to give a two-component developer.

TABLE 1

| | | Colorant | | | Pre-mixing | Dielectric |
|---|---|---|---|---|---|---|
| | | | Carbon | Magnetic | Time | Loss |
| | Resin Binder | Composite Oxide | Black | Powder | (seconds) | Tangent |
| Example 1 | Resin A/100 | MC-7/9 | — | — | 120 | 0.00222 |
| Example 2 | Resin B/100 | MC-7/9 | — | — | 120 | 0.00291 |
| Example 3 | Resin A/100 | MC-3/9 | — | — | 120 | 0.00268 |
| Example 4 | Resin A/100 | Dye Pyroxide | — | — | 120 | 0.00299 |
| | | Black No. 2/9 | | | | |
| Example 5 | Resin A/100 | ETB-200/9 | — | — | 120 | 0.00372 |
| Example 6 | Resin A/100 | MC-7/12 | — | — | 120 | 0.00238 |
| Example 7 | Resin A/100 | MC-7/6 | 2 | — | 120 | 0.00314 |
| Example 8 | Resin A/100 | MC-7/6 | 2 | 3 | 120 | 0.00386 |
| Example 9 | Resin C/100 | MC-7/9 | — | — | 120 | 0.00210 |
| Example 10 | Resin A/100 | MC-7/9 | — | — | 60 | 0.00628 |
| Example 11 | Resin A/100 | MC-10/9 | — | — | 120 | 0.00350 |
| Example 12 | Resin A/100 | K-002/9 | — | — | 120 | 0.00345 |
| Comparative | Resin A/100 | HSB-605/9 | — | — | 120 | 0.00362 |
| Example 1 | | | | | | |
| Comparative | Resin A/100 | HSB-603/9 | — | — | 120 | 0.00359 |
| Example 2 | | | | | | |
| Comparative | Resin A/100 | HSB-603/20 | — | — | 120 | 0.00317 |
| Example 3 | | | | | | |
| Comparative | Resin A/100 | — | 9 | — | 120 | 0.00439 |
| Example 4 | | | | | | |

Note) The amounts used are all expressed in “parts by weight.”

In the table, as the carbon black, there was used “Monarch 880” (commercially available from Cabot Corporation).

As the magnetic powder, there was used magnetite “ETP-1002” (commercially available from Toda Kogyo Corp.).

As the composite oxide, those summarized in the following table were used:

| | BET Specific | Magnetic | Major |
|---|---|---|---|
| | Surface Area | Properties | Metal |
| Composite Oxide | (m²/g) | (Am²/kg) | Contained |
| MC-7 (commercially available | 60.6 | 0.5 | Fe, Mn |
| from MITSUI MINING & | | | |
| SMELTING CO., LTD.) | | | |
| MC-3 (commercially available | 47.3 | 1.1 | Fe, Mn, Cu |
| from MITSUI MINING & | | | |
| SMELTING CO., LTD.) | | | |
| Dye Pyroxide Black No. 2 | 56.0 | 9.0 | Fe, Mn, Cu |
| (commercially available from | | | |
| DAINICHISEIKA COLOR & | | | |
| CHEMICALS MFG. CO., | | | |
| LTD.) | | | |
| ETB-200 (commercially | 7.2 | 1.1 | Fe, Ti |
| available from Titan | | | |
| Kogyo K.K.) | | | |
| MC-10 (commercially | 41.6 | 30.7 | Fe, Mg, Al |
| available from MITSUI | | | |
| MINING & SMELTING CO., | | | |
| LTD.) | | | |
| K-002 (commercially | 10.8 | 24.7 | Fe, Ti |
| available from Toda Kogyo | | | |
| Corp.) | | | |
| HSB-605 (commercially | 6.0 | 0.3 | Fe, Mn |
| available from Toda Kogyo | | | |
| Corp.) | | | |
| HSB-603 (commercially | 2.8 | 0.2 | Fe, Mn |
| available from Toda Kogyo | | | |
| Corp.) | | | |

### Test Example 1

A developer was loaded in a contact development device “Infoprint 4000 IS1” (commercially available from-IBM Japan, Ltd., linear speed: 1066 mm/sec, resolution: 240 dpi, development system: 3 magnet rollers and selenium photoconductor, reversal development). A 1000000-sheet continuous printing with a printing pattern having 8% blackened ratio including a solid image of 2.5 square centimeters was carried out using a continuous feeding paper with 11×18 inches. Thereafter, the triboelectric charges, the image density and the amount of scattered toner were determined by the methods described below, and the halftone reproducibility and the extent of flare generation were evaluated. The results are shown in Table 2.

[Triboelectric Charges]

The triboelectric charges are measured using a Q/M meter (commercially available from Epping GmbH). A specified amount of a developer is supplied in a cell provided in the Q/M meter, and only toner is aspirated for 90 seconds through a sieve having a sieve opening of 32 μm (made of stainless steel, twilled, wire diameter: 0.0035 mm). The voltage change generated on the carrier at this time is monitored, and the value of [Total Triboelectric Charges After 90 Seconds (μC)/Amount of Toner Aspirated (g)] is determined as the triboelectric charges (μC/g).

[Image Density]

A black solid image part of a printout is determined using a “Model 938 Spectrodensitometer” (commercially available from X-Rite, aperture: 20 mm, determination mode: Yxy, light source: D₆₅, angle of scope: 10 degree). The image density was calculated in accordance with the following equation:

Image Density=log(1/Y)

[Amount of Scattered Toner]

The switch of the fan of a digital dust indicator “Model P-5” (commercially available from SHIBATA SCIENTIFIC TECHNOLOGY LTD.) is turned on, and the determination time is set to 1 minute. The amount of scattered toner is determined during continuous printing by setting a hose extending from the dust indicator above the magnet roll of a printer.

[Halftone Reproducibility]

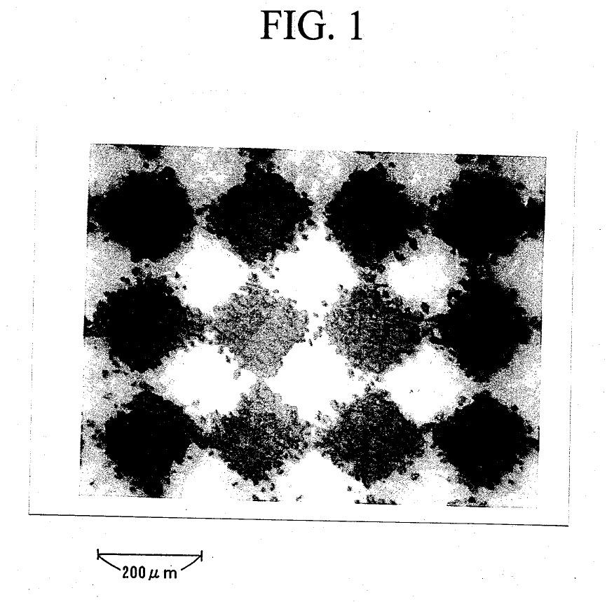

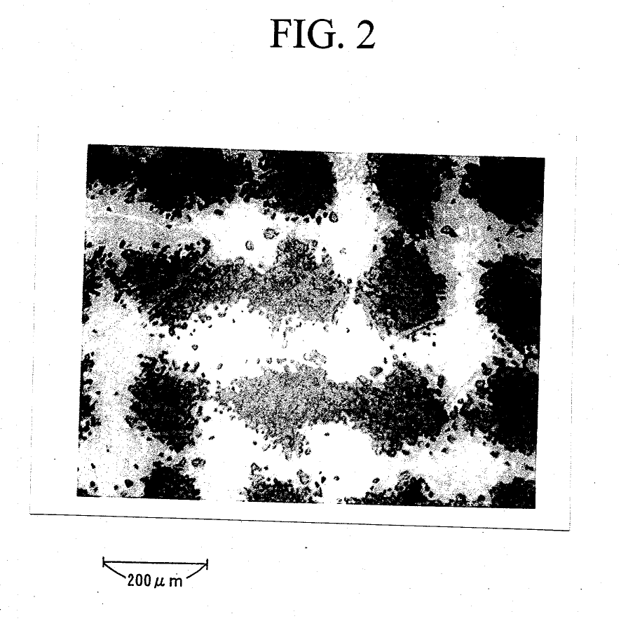

Printing of a halftone image was carried out, and the reproducibility of the image was confirmed using a microscope (magnification: ×125). In the microscopic observation, reproducibility, shape, scattering state and the like are totally evaluated by visual observation, and ranked in equal intervals from 1 to 5, with the highest rank of 5 to the lowest rank of 1. The evaluation which can be accepted for practical purposes is rank 3 or higher. Incidentally, the photomicrographs of the halftone images of Example 1 and Comparative Example 2 are shown in FIG. 1 (Rank 5) and FIG. 2 (Rank 2), respectively.

[Flare]

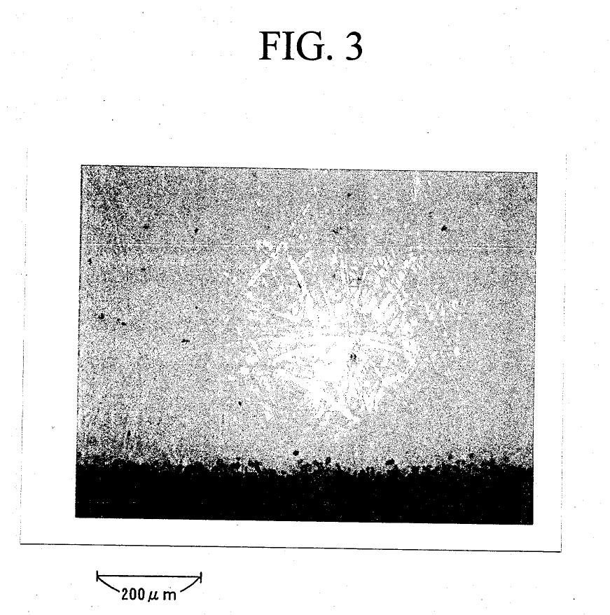

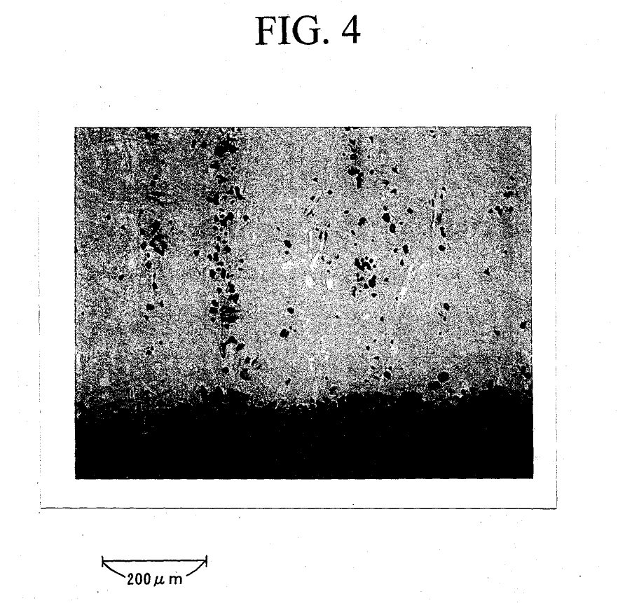

A flare generated on an edge part of a solid image of 2.5 square centimeters was observed using a microscope (magnification: ×125), and the extent of flare is totally evaluated, and ranked in equal intervals from 1 to 5, with the highest rank of 5 to the lowest rank of 1. The evaluation which can be accepted for practical purposes is rank 2 or higher. Incidentally, the photomicrographs of Example 11 and Comparative Example 4 are shown in FIG. 3 (Rank 5) and FIG. 4 (Rank 1), respectively.

TABLE 2

| | Triboelectric | | Scattered | Halftone | |
|---|---|---|---|---|---|
| | Charges | Image | Amount | Reproduc- | |
| | (μC/g) | Density | (/minute) | ibility | Flare |
| Example 1 | 20.3 | 1.35 | 8 | 5 | 4 |
| Example 2 | 19.3 | 1.34 | 15 | 5 | 4 |
| Example 3 | 21.0 | 1.36 | 17 | 5 | 4 |
| Example 4 | 21.1 | 1.34 | 13 | 5 | 4 |
| Example 5 | 20.7 | 1.25 | 28 | 3 | 3 |
| Example 6 | 17.4 | 1.44 | 19 | 5 | 2 |
| Example 7 | 17.1 | 1.43 | 17 | 4 | 2 |
| Example 8 | 17.1 | 1.40 | 4 | 4 | 3 |
| Example 9 | 23.4 | 1.20 | 43 | 3 | 3 |
| Example 10 | 16.8 | 1.51 | 39 | 4 | 2 |
| Example 11 | 20.1 | 1.36 | 7 | 5 | 5 |
| Example 12 | 21.5 | 1.35 | 6 | 5 | 5 |
| Comparative | 16.4 | 1.09 | 70 | 2 | 3 |
| Example 1 | | | | | |
| Comparative | 17.3 | 1.11 | 93 | 2 | 2 |
| Example 2 | | | | | |
| Comparative | 13.5 | 1.34 | 307 | 2 | 2 |
| Example 3 | | | | | |
| Comparative | 15.3 | 1.45 | 84 | 1 | 1 |
| Example 4 | | | | | |

From the above results, Examples 1 to 12 have a desired image density of 1.2 or more, so that they have sufficient blackened degree as black toners. In addition, as for the amount of scattered toner, the results show that all Examples are low as compared with the desired level of 50/minute, and the halftone reproducibility of each Example is excellent. Further, as for the flare, the results show that Example 11 in which the composite oxide comprising Fe, Mg and Al is contained and Example 12 in which the composite oxide comprising Fe and Ti is contained are especially excellent, and Examples 1 to 4 give excellent results next to these. Among them, in Example 7, since the composite oxide and the carbon black are used together, the triboelectric charges are reduced, the distribution of the triboelectric charges is broad, toner scattering is generated in some degree due to the toner having low triboelectric charges, and flare is slightly generated. In Example 8, since the magnetic powder of magnetite is further added, the amount of toner scattering is even smaller. In Example 9, since the styrene-acrylic resin is used, the amount of toner scattering is slightly large, the halftone reproducibility is slightly decreased, and flare is slightly generated. In Example 10, the value of the dielectric loss tangent is slightly high, and the dispersibility of the composite oxide is slightly decreased, thereby causing partial aggregation. Therefore, the triboelectric charges are reduced and the distribution of the triboelectric charges is broad due to the decrease in the surface resistivity, toner scattering is slightly increased due to the toner having low triboelectric charges, and flare is slightly generated.

On the other hand, in Comparative Examples 1 and 2, a composite oxide having a small specific surface area was used. Therefore, the blackened degree is poor, the image density is low, and the surface resistivity is too high, the initial rise in the triboelectric charges is delayed, the triboelectric charges are reduced and the distribution thereof is broad, toner scattering is generated, and the halftone reproducibility is poor in each Comparative Example. In Comparative Example 3, the amount of the composite oxide used in Comparative Example 2 is increased. As a result, the desired value is attained for image density, but the amount of scattered toner is increased due to the increase in the true specific gravity of the toner, and the halftone reproducibility is poor and the flare is generated. In Comparative Example 4, since only carbon black is used as a black colorant, there is no problem with the image density, but the triboelectric charges are reduced, and the distribution of the triboelectric charges is broad. As a result, toner scattering is generated due to the toner having low triboelectric charges. Also, since the surface resistivity of the toner is low, the developing bias is likely to be leaked. Therefore, the toner fixed image is distorted in the development and transferring steps, the halftone reproducibility is deteriorated, and flare is generated.

According to the present invention, there can be provided a black toner for two-component development which has an excellent blacked degree and hardly causes toner scattering, and a two-component developer comprising the toner. Further, since the toner and the two-component developer of the present invention are excellent in fine halftone reproducibility and prevention of flare, they can be suitably used for a reversal development method.

What is claimed is:

1. A black toner for two-component development, comprising:
a resin binder; and
a black colorant comprising a composite oxide of two or more metals, the composite oxide having a BET specific surface area of 7 m²/g or more.

2. The black toner according to claim 1, wherein the composite oxide has a magnetic property showing magnetization of 0.1 to 50 Am²/kg when a magnetic field of 796 kA/m is applied.

3. The black toner according to claim 1, wherein the black toner is used together with a resin-coated carrier.

4. The black toner according to claim 1, which is usable for reversal development.

5. The black toner according to claim 1, wherein the black toner has a dielectric loss tangent (tan δ) of 0.001 to 0.006.

6. The black toner according to claim 1, wherein the composite oxide has an average particle size of 5 nm to 1 μm.

7. The black toner according to claim 1, wherein the composite oxide is contained in an amount of 30 parts by weight or less, based on 100 parts by weight of the resin binder.

8. The black toner according to claim 1, wherein the resin binder comprises a polyester.

9. The black toner according to claim 8, wherein the polyester is a resin obtainable by polycondensing an alcohol component containing 5% by mol or more of a compound represented by the formula (I): 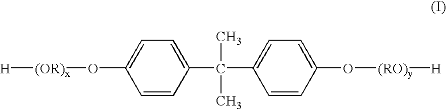
wherein R is an alkylene group having 2 or 3 carbon atoms; each of x and y is a positive number, wherein a sum of x and y is 1 to 16, with a carboxylic acid component.

10. The black toner according to claim 8 or 9, wherein the polyester is a resin obtainable by polycondensing an alcohol component with a carboxylic acid component containing 5 to 50% by mol of a tricarboxylic or higher polycarboxylic acid component.

11. The black toner according to claim 1, which is usable for formation of full-color fixed images.

12. The black toner according to claim 1, wherein the black toner is a positively chargeable toner.

13. A two-component developer comprising the black toner for two-component development of claim 1 and a resin-coated carrier.

14. A process for development of a two-component developer, comprising applying the two-component developer of claim 13 to a development device for two-component development.

15. The process according to claim 14, wherein the development device is a device for reversal development.

16. The process according to claim 14, wherein the development device is a device for full-color development.
